(19) United States
(12) Patent Application Publication
(10) Pub. No.: US 2023/0145158 A1
(43) Pub. Date: May 11, 2023

(54) Aerated Fat Emulsion

(71) Applicant: Bunge Loders Croklaan B.V., Wormerveer (NL)

(72) Inventors: Bastiaan Jeroen Victor Verkuijl, Wormerveer (NL); Hang Kam Man, Wormerveer (NL)

(73) Assignee: Bunge Loders Croklaan B.V., Wormerveer (NL)

(21) Appl. No.: 17/794,643

(22) PCT Filed: Jan. 21, 2021
(86) PCT No.: PCT/EP2021/051343

§ 371 Date: Jul. 22, 2022

(30) Foreign Application Priority Data
Jan. 24, 2020 (EP) 20275016.2

(51) Int. Cl. A23D 7/04; A23D 7/00; A23G 3/40; A21D 2/16; A23G 3/34

(52) U.S. Cl. CPC A23D 7/04; A23D 7/003; A23G 3/40; A21D 2/165; A23G 3/346

(57) ABSTRACT

An aerated fat emulsion comprises: from 10% to 90% by weight of water; and from 10% to 90% by weight of a fat composition, wherein the fat composition comprises: from 75% to 99% by weight of a lauric fat comprising from 35% to 65% lauric acid (C12:0); said percentages of acids referring to acids bound as acyl groups in glycerides in the fat and being based on the total weight of C8 to C24 fatty acids; and from 1% to 25% by weight of an interesterified fat comprising from 30% to 70% by weight of total stearic acid (C18:0) and arachidic acid (C20:0); from 1% to 10% by weight of palmitic acid (C16:0) and less than 2% by weight of lauric acid (C12:0), said percentages of acids referring to acids bound as acyl groups in glycerides in the fat and being based on the total weight of C8 to C24 fatty acids; and from 5% to 35% by weight of the combined amounts of StStSt and AStSt triglycerides, based on total triglycerides present in the composition, wherein St is stearic acid and A is arachidic acid.

This invention relates to an aerated fat emulsion, a method of making the aerated fat emulsion, uses thereof and a confectionery product or a bakery product comprising the aerated fat emulsion.

### BACKGROUND

Edible aerated oil-in-water emulsions like whipped cream are well known food products comprising a continuous water phase and oil droplets suspended in the aqueous phase.

Fats and oils are important ingredients of food products. Fats and oils are occasionally subjected to an interesterification process which randomly redistributes the fatty acid acyl residues amongst the glyceride molecules. This process can alter the physical properties of the fat or oil.

Lauric oils, such as coconut oil, are vegetable oils comprising predominantly short- and medium chain fatty acid (caprylic acid (C8:0), capric acid (C10:0), lauric acid (C12:0) and myristic acid (C14:0)). Lauric oils are extensively used in the food industries, where the uses include filling cream, ice cream, non-dairy whipped cream, coffee whiteners, cacao butter substitutes and medium chain triglycerides (MCTs).

Sal fat is an edible oil extracted from the seeds of Shorea reobusta. Shea butter is a fat obtained from the nuts of Vitellaria paradoxa. Both fats are relatively rich in stearic acid (C18:0) and oleic acid (C18:1) and can be fractionated to produce a stearin fraction rich in StOSt (1,3-distearoyl-2-oleoyl glyceride) often to be used in a cocoa butter equivalent.

EP A1 0 667 104 discloses a low-fat cream which can be produced without the necessity for using a large amount of a specified emulsifier even when the fat content is as low as 40% or less and a fat to be used for producing the cream, where the fat comprises at least 30% of a SUS-type glyceride and 5-60% of a laurin fat.

EP A1 3 466 278 relates to an oil-in-water food emulsion comprising, in weight percent based on the total weight of the emulsion, between 15 and 45% of a fat phase, the fat phase comprising glycerides wherein at least 65% of the chains deriving from fatty acids, in weight percent based on the total of weight of the chains, are chains having 18 carbon atoms; and at least one emulsifier.

WO 2012/052471 A1 provides an edible product containing 15-80 wt % of triglycerides, 20-85 wt % of filler, and at most 15 wt % water, wherein the triglycerides contain as acid residues 20-70 wt % of total SAFA, at most 5 wt % of TFA, thereby C8, C10 and C12 in a weight ratio of (C8+C10+C12)/total SAFA of at least 10% and a weight ratio of (C8+C10)/C12 of at least 5%, whereby the weight ratio DIB is at least 1.5 and the weight ratio of B/total SAFA is at most 0.5, in which D represents the sum of the amounts of all MUFA and PUFA, and B represents the sum of the amounts of C14 and C16, and which triglyceride composition has an SFC at 20° C. of at least 5 wt %.

WO 2016/150968 A1 relates to a food composition comprising a lipid-in-water emulsion wherein gas is dispersed in the lipid in the form of a foam.

WO 2019/020714 A1 discloses a non-hydrogenated fat composition comprising greater than 28% by weight stearic acid (C18:0) fatty acid residues; greater than 44% by weight oleic acid (C18:1) fatty acid residues, and less than 10% by weight of palmitic acid (C16) fatty acid residues, based on the total C8-C24 fatty acid residues, and greater than 30% by weight of the combined amounts of StOSt, StStO, StOO and OStO triglycerides based on the total glycerides present in the composition, wherein the weight ratio of (StOSt+StStO)/(StOO+OStO) is from 0.6-1.5.

WO 2019/185444 A1 provides a non-hydrogenated fat composition comprising from 3.2% to 10% by weight of total caprylic acid (C8:0) and capric acid (C10:0); from 13% to 32% by weight lauric acid; and from 20% to 45% by weight stearic acid (C18:0) fatty acid residues; the percentages of acids referring to acids bound as acyl groups in glycerides in the fat composition and being based on the total weight of C8 to C24 fatty acids; and from 7% to 15% by weight CN46 triglycerides; from 4% to 30% by weight CN54 triglycerides; and from 15% to 28% by weight of total CN42 triglycerides and CN44 triglycerides; the percentages of triglycerides referring to the total triglycerides present in the composition.

There remains a need for an aerated fat emulsion which has an improved air incorporation in order to improve the organoleptic properties while the texture of the product is still desirable.

### DESCRIPTION OF THE INVENTION

According to the present invention, there is provided an aerated fat emulsion comprising from 10% to 90% by weight of water; and from 10% to 90% by weight of a fat composition, wherein the fat composition comprises:

from 75% to 99% by weight of a lauric fat comprising from 35% to 65% lauric acid (C12:0); said percentages of acids referring to acids bound as acyl groups in glycerides in the fat and being based on the total weight of C8 to C24 fatty acids; and
from 1% to 25% by weight of an interesterified fat comprising from 30% to 70% by weight of total stearic acid (C18:0) and arachidic acid (C20:0); from 1% to 10% by weight of palmitic acid (C16:0) and less than 2% by weight of lauric acid (C12:0), said percentages of acids referring to acids bound as acyl groups in glycerides in the fat and being based on the total weight of C8 to C24 fatty acids; and from 5% to 35% by weight of combined amounts of StStSt and AStSt triglycerides, based on total triglycerides present in the composition, wherein St is stearic acid and A is arachidic acid.

The aerated fat emulsion of this invention has been found to be particularly advantageous when used in confectionery products or bakery products to provide improved aeration which is desirable to obtain the desired organoleptic properties of the products. In particular, the aerated fat emulsion according to the invention also surprisingly maintains good texture properties which allows the products to have a good appearance and to be processable and transportable.

The term “fat emulsion” refers to a mixture of at least a fat phase and an aqueous phase which are immiscible. The fat emulsions for aeration according to the invention are typically oil in water emulsions.

The term “aerated” refers to incorporation of a gas, typically air, into the emulsion.

The term “fat” refers to glyceride fats and oils containing fatty acid acyl groups and does not imply any particular melting point. The term “oil” is used synonymously with “fat”.

The term “fatty acid” refers to straight chain saturated or unsaturated (including mono- and poly unsaturated) carboxylic acids having from 8 to 24 carbon atoms. A fatty acid having x carbon atoms and y double bonds may be denoted Cx:y. For example, palmitic acid may be denoted C16:0 and oleic acid may be denoted C18:1. Percentages of fatty acids in compositions referred to herein include acyl groups in tri-, di- and mono-glycerides present in the glycerides and are based on the total weight of C8 to C24 fatty acids. The fatty acid profile (i.e., composition) may be determined, for example, by fatty acid methyl ester analysis (FAME) using gas chromatography according to ISO 12966-2 and ISO 12966-4.

The fat composition of the aerated fat emulsion according to the invention may be made from naturally occurring or synthetic fats, fractions of naturally occurring or synthetic fats, or mixtures thereof.

Amounts of triglycerides specified herein are percentages by weight based on total triglycerides present in the fat composition. The notation triglyceride XYZ denotes triglycerides having fatty acid acyl groups X, Y and Z at any of the 1-, 2- and 3-positions of the glyceride. The notation A2B includes both AAB and ABA, and AB2 includes both ABB and BAB. Triglyceride content may be determined for example by GC (ISO 23275).

The term “lauric fat” refers to a fat containing mainly lauric acid (C12:0), typically derived from sources such as coconut oil or palm kernel oil.

The term “interesterified fat” refers to a fat subjected to a random non-specific redistribution of the fatty acid moieties present in a triglyceride oil over its glycerol moieties.

The aerated fat emulsion according to the invention preferably has an overrun from 100% to 400%, more preferably from 150% to 300% and even more preferably from 200% to 300%.

The term “overrun” refers to the percentage increase in volume that occurred as a result of the gas incorporation. The overrun is calculated as follows: (density in g/ml of unwhipped cream/density in g/ml of whipped cream)*100%.

The aerated fat emulsion according to the invention preferably comprises from 20% to 80% by weight of water and from 10% to 70% by weight of the fat composition. More preferably, the aerated fat emulsion according to the invention comprises from 30% to 70% by weight of water and from 15% to 65% by weight of the fat composition. Even more preferably, the aerated fat emulsion according to the invention comprises 35% to 65% by weight of water and from 20% to 55% by weight of the fat composition. Most preferably, the aerated fat emulsion according to the invention comprises from 40% to 55% by weight of water and from 25% to 50% by weight of the fat composition.

The fat composition of the aerated fat emulsion according to the invention comprises from 75% to 99% by weight of a lauric fat, preferably from 80% to 99% by weight, more preferably from 85% to 99% by weight and even more preferably from 90% to 99% by weight.

The lauric fat of the fat composition of the aerated fat emulsion according to the invention comprises from 35% to 65% by weight of lauric acid; said percentage referring to acid bound as acyl groups in glycerides in the fat and being based on the total weight of C8 to C24 fatty acids, preferably from 40% to 60% by weight, more preferably from 42% to 58% and even more preferably from 43% to 55% by weight.

The lauric fat of the fat composition of the aerated fat emulsion according to the invention is preferably selected from coconut oil, palm kernel oil, fully hydrogenated coconut oil, fully hydrogenated palm kernel oil, fractions thereof and mixtures thereof. More preferably, the lauric fat of the fat composition of the aerated fat emulsion according to the invention consists of coconut oil.

The fat composition of the aerated fat emulsion according to the invention comprises from 1% to 25% by weight of the interesterified fat, preferably from 1% to 20% by weight, more preferably from 1% to 15% by weight and even more preferably from 1% to 10% by weight.

The interesterified fat of the fat composition of the aerated fat emulsion according to the invention comprises from 30% to 70% by weight of total stearic acid (C18:0) and arachidic acid (C20:0); from 1% to 10% by weight of palmitic acid (C16:0) and less than 2% by weight of lauric acid (C12:0); said percentage of acids referring to acids bound as acyl groups in glycerides in the fat and being based on the total weight of C8 to C24 fatty acids. Preferably, the interesterified fat of the fat composition of the aerated fat emulsion according to the invention comprises from 35% to 68% by weight of total stearic acid (C18:0) and arachidic acid (C20:0); from 1% to 9% by weight of palmitic acid (C16:0) and from 0.0% to 1.5% by weight of lauric acid (C12:0); said percentage of acids referring to acids bound as acyl groups in glycerides in the fat and being based on the total weight of C8 to C24 fatty acids. More preferably, the interesterified fat of the fat composition of the aerated fat emulsion according to the invention comprises from 40% to 65% by weight of total stearic acid (C18:0) and arachidic acid (C20:0); from 1% to 8% by weight of palmitic acid (C16:0) and from 0.1% to 1.0% by weight of lauric acid (C12:0); said percentage of acids referring to acids bound as acyl groups in glycerides and being based on the total weight of C8 to C24 fatty acids.

The interesterified fat of the fat composition of the aerated fat emulsion according to the invention comprises from 5% to 35% by weight of the combined amounts of StStSt and AStSt triglycerides, based on total triglycerides present in the composition, wherein St is stearic acid and A is arachidic acid, preferably from 7% to 30% by weight, more preferably from 8% to 28% by weight and even more preferably from 9% to 26%.

In a preferred embodiment, the aerated fat emulsion comprises: from 20% to 80% by weight of water; and from 10% to 70% by weight of a fat composition, wherein the fat composition comprises: from 80% to 99% by weight of a lauric fat comprising from 40% to 60% lauric acid (C12:0); said percentages of acids referring to acids bound as acyl groups in glycerides in the fat and being based on the total weight of C8 to C24 fatty acids; and from 1% to 20% by weight of an interesterified fat comprising from 35% to 68% by weight of total stearic acid (C18:0) and arachidic acid (C20:0); from 1% to 9% by weight of palmitic acid (C16:0) and from 0.0% to 1.5% by weight of lauric acid (C12:0); and from 7% to 30% by weight of the combined amounts of StStSt and AStSt triglycerides, based on total triglycerides present in the composition, wherein St is stearic acid and A is arachidic acid.

In a more preferred embodiment, the aerated fat emulsion comprises: from 30% to 70% by weight of water; and from 15% to 65% by weight of a fat composition, wherein the fat composition comprises: from 85% to 99% by weight of a lauric fat comprising from 42% to 58% lauric acid (C12:0); said percentages of acids referring to acids bound as acyl groups in glycerides in the fat and being based on the total weight of C8 to C24 fatty acids; and from 1% to 15% by weight of an interesterified fat comprising from 40% to 65% by weight of total stearic acid (C18:0) and arachidic acid (C20:0); from 1% to 8% by weight of palmitic acid (C16:0) and from 0.1% to 1.0% by weight of lauric acid (C12:0); and from 8% to 28% by weight of the combined amounts of StStSt and AStSt triglycerides, based on total triglycerides present in the composition, wherein St is stearic acid and A is arachidic acid.

In an even more preferred embodiment, the aerated fat emulsion comprises: from 35% to 65% by weight of water; and from 20% to 55% by weight of a fat composition, wherein the fat composition comprises: from 90% to 99% by weight of a lauric fat comprising from 43% to 55% lauric acid (C12:0); said percentages of acids referring to acids bound as acyl groups in glycerides in the fat and being based on the total weight of C8 to C24 fatty acids; and from 1% to 10% by weight of an interesterified fat comprising from 40% to 65% by weight of total stearic acid (C18:0) and arachidic acid (C20:0); from 1% to 8% by weight of palmitic acid (C16:0) and from 0.1% to 1.0% by weight of lauric acid (C12:0); and from 9% to 26% by weight of the combined amounts of StStSt and AStSt triglycerides, based on total triglycerides present in the composition, wherein St is stearic acid and A is arachidic acid.

The interesterified fat of the fat composition of the aerated fat emulsion according to the invention preferably has a weight ratio of StOSt:StOO less than 2.5, more preferably from 0.5 to 2.3, wherein St is stearic acid and O is oleic acid.

The interesterified fat of the fat composition of the aerated fat emulsion according to the invention preferably has from 45.0 to 68.0 solid fat content at 10° C., more preferably from 48.0 to 67.5; measured on unstabilized fat according to ISO 8292-1.

The interesterified fat of the fat composition of the aerated fat emulsion according to the invention preferably has from 15.0 to 70.0 solid fat content at 25° C., more preferably from 20.0 to 65.0; measured on unstabilized fat according to ISO 8292-1.

The interesterified fat of the fat composition of the aerated fat emulsion according to the invention preferably has from 15.0 to 59.0 solid fat content at 30° C., more preferably from 20.0 to 55.0; measured on unstabilized fat according to ISO 8292-1.

The interesterified fat of the fat composition of the aerated fat emulsion according to the invention preferably has from 10.0 to 55.0 solid fat content at 35° C., more preferably from 15.0 to 50.0; measured on unstabilized fat according to ISO 8292-1.

The interesterified fat of the fat composition of the aerated fat emulsion according to the invention preferably has from 5.0 to 45.0 solid fat content at 40° C., more preferably from 10.0 to 40.0; measured on unstabilized fat according to ISO 8292-1.

In a preferred embodiment, the aerated fat emulsion comprises: from 30% to 70% by weight of water; and from 15% to 65% by weight of a fat composition, wherein the fat composition comprises: from 85% to 99% by weight of a lauric fat comprising from 42% to 58% lauric acid (C12:0); said percentages of acids referring to acids bound as acyl groups in glycerides in the fat and being based on the total weight of C8 to C24 fatty acids; and from 1% to 15% by weight of an interesterified fat comprising from 40% to 65% by weight of total stearic acid (C18:0) and arachidic acid (C20:0); from 1% to 8% by weight of palmitic acid (C16:0) and from 0.1% to 1.0% by weight of lauric acid (C12:0); and from 8% to 28% by weight of the combined amounts of StStSt and AStSt triglycerides and a weight ratio of StOSt:StOO less than 2.5, based on total triglycerides present in the composition, wherein St is stearic acid, A is arachidic acid and O is oleic acid.

In a more preferred embodiment, the aerated fat emulsion comprises: from 35% to 65% by weight of water; and from 20% to 55% by weight of a fat composition, wherein the fat composition comprises: from 90% to 99% by weight of a lauric fat comprising from 43% to 55% lauric acid (C12:0); said percentages of acids referring to acids bound as acyl groups in glycerides in the fat and being based on the total weight of C8 to C24 fatty acids; and from 1% to 10% by weight of an interesterified fat comprising from 40% to 65% by weight of total stearic acid (C18:0) and arachidic acid (C20:0); from 1% to 8% by weight of palmitic acid (C16:0) and from 0.1% to 1.0% by weight of lauric acid (C12:0); and from 9% to 26% by weight of the combined amounts of StStSt and AStSt triglycerides and a weight ratio of StOSt:StOO from 0.5 to 2.3, based on total triglycerides present in the composition, wherein St is stearic acid, A is arachidic acid and O is oleic acid.

In an even more preferred embodiment, the aerated fat emulsion comprises: from 30% to 70% by weight of water; and from 15% to 65% by weight of a fat composition, wherein the fat composition comprises: from 85% to 99% by weight of a lauric fat comprising from 42% to 58% lauric acid (C12:0); said percentages of acids referring to acids bound as acyl groups in glycerides in the fat and being based on the total weight of C8 to C24 fatty acids; and from 1% to 15% by weight of an interesterified fat comprising from 40% to 65% by weight of total stearic acid (C18:0) and arachidic acid (C20:0); from 1% to 8% by weight of palmitic acid (C16:0) and from 0.1% to 1.0% by weight of lauric acid (C12:0); and from 8% to 28% by weight of the combined amounts of StStSt and AStSt triglycerides and a weight ratio of StOSt:StOO less than 2.5, based on total triglycerides present in the composition, wherein St is stearic acid, A is arachidic acid and O is oleic acid; and from 45.0 to 68.0 solid fat content at 10° C.; and from 15.0 to 70.0 solid fat content at 25° C.; and from 15.0 to 59.0 solid fat content at 30° C.; and from 10.0 to 55.0 solid fat content at 35° C.; and from 5.0 to 45.0 solid fat content at 40° C.; measured on unstabilized fat according to ISO 8292-1.

In a most preferred embodiment, the aerated fat emulsion comprises: from 35% to 65% by weight of water; and from 20% to 55% by weight of a fat composition, wherein the fat composition comprises: from 90% to 99% by weight of a lauric fat comprising from 43% to 55% lauric acid (C12:0); said percentages of acids referring to acids bound as acyl groups in glycerides in the fat and being based on the total weight of C8 to C24 fatty acids; and from 1% to 10% by weight of an interesterified fat comprising from 40% to 65% by weight of total stearic acid (C18:0) and arachidic acid (C20:0); from 1% to 8% by weight of palmitic acid (C16:0) and from 0.1% to 1.0% by weight of lauric acid (C12:0); and from 9% to 26% by weight of the combined amounts of StStSt and AStSt triglycerides and a weight ratio of StOSt:StOO from 0.5 to 2.3, based on total triglycerides present in the composition, wherein St is stearic acid, A is arachidic acid and O is oleic acid; and from 48.0 to 67.5 solid fat content at 10° C.; and from 20.0 to 65.0 solid fat content at 25° C.; and from 20.0 to 55.0 solid fat content at 30° C.; and from 15.0 to 50.0 solid fat content at 35° C.; and from 10.0 to 40.0 solid fat content at 40° C.; measured on unstabilized fat according to ISO 8292-1.

The interesterified fat of the fat composition of the aerated fat emulsion according to the invention is preferably selected from interesterified shea butter, interesterified shea stearin, interesterified sal butter, interesterified sal stearin, interesterified kokum butter, interesterified kokum butter stearin, interesterified cocoa butter, interesterified cocoa butter stearin and mixtures thereof. More preferably, the interesterified fat of the fat composition of the aerated fat emulsion according to the invention is selected from interesterified sal butter, interesterified shea stearin and mixtures thereof.

The aerated fat emulsion according to the invention preferably comprises from 35% to 65% by weight of water; from 20% to 55% by weight of the fat composition; and from 5% to 25% by weight of sugar. More preferably, the aerated fat emulsion according to the invention comprises from 40% to 55% by weight of water; from 25% to 50% by weight of the fat composition; and from 10% to 20% by weight of sugar.

The aerated fat emulsion according to the invention preferably further comprises from 0.5% to 2% by weight of sodium caseinate, more preferably from 0.8% to 1.2% by weight. Accordingly, the aerated fat emulsion according to the invention preferably comprises from 40% to 55% by weight of water; from 25% to 50% by weight of the fat composition; from 10% to 20% by weight of sugar; and 0.8% to 1.2% by weight of sodium caseinate.

Accordingly, in a preferred embodiment, the aerated fat emulsion comprises: from 35% to 65% by weight of water; from 5% to 25% by weight of sugar; and from 20% to 55% by weight of a fat composition, wherein the fat composition comprises: from 90% to 99% by weight of a lauric fat comprising from 43% to 55% lauric acid (C12:0); said percentages of acids referring to acids bound as acyl groups in glycerides in the fat and being based on the total weight of C8 to C24 fatty acids; and from 1% to 10% by weight of an interesterified fat comprising from 40% to 65% by weight of total stearic acid (C18:0) and arachidic acid (C20:0); from 1% to 8% by weight of palmitic acid (C16:0) and from 0.1% to 1.0% by weight of lauric acid (C12:0); and from 9% to 26% by weight of the combined amounts of StStSt and AStSt triglycerides and a weight ratio of StOSt:StOO from 0.5 to 2.3, based on total triglycerides present in the composition, wherein St is stearic acid, A is arachidic acid and O is oleic acid; and from 48.0 to 67.5 solid fat content at 10° C.; and from 20.0 to 65.0 solid fat content at 25° C.; and from 20.0 to 55.0 solid fat content at 30° C.; and from 15.0 to 50.0 solid fat content at 35° C.; and from 10.0 to 40.0 solid fat content at 40° C.; measured on unstabilized fat according to ISO 8292-1.

The aerated fat emulsion according to the invention is preferably whipped cream.

Accordingly, in a preferred embodiment, the whipped cream comprises: from 35% to 65% by weight of water; from 5% to 25% by weight of sugar; and from 20% to 55% by weight of a fat composition, wherein the fat composition comprises: from 90% to 99% by weight of a lauric fat comprising from 43% to 55% lauric acid (C12:0); said percentages of acids referring to acids bound as acyl groups in glycerides in the fat and being based on the total weight of C8 to C24 fatty acids; and from 1% to 10% by weight of an interesterified fat comprising from 40% to 65% by weight of total stearic acid (C18:0) and arachidic acid (C20:0); from 1% to 8% by weight of palmitic acid (C16:0) and from 0.1% to 1.0% by weight of lauric acid (C12:0); and from 9% to 26% by weight of the combined amounts of StStSt and AStSt triglycerides and a weight ratio of StOSt:StOO from 0.5 to 2.3, based on total triglycerides present in the composition, wherein St is stearic acid, A is arachidic acid and O is oleic acid; and from 48.0 to 67.5 solid fat content at 10° C.; and from 20.0 to 65.0 solid fat content at 25° C.; and from 20.0 to 55.0 solid fat content at 30° C.; and from 15.0 to 50.0 solid fat content at 35° C.; and from 10.0 to 40.0 solid fat content at 40° C.; measured on unstabilized fat according to ISO 8292-1.

The invention also relates to a method of making an aerated fat emulsion comprising the steps of: a) providing a mixture comprising from 10% to 90% by weight of water and from 10% to 90% by weight of a fat composition, wherein the fat composition comprises: from 75% to 99% by weight of a lauric fat comprising from 35% to 65% lauric acid (C12:0); and from 1% to 25% by weight of an interesterified fat comprising from 30% to 70% by weight of total stearic acid (C18:0) and arachidic acid (C20:0); from 1% to 10% by weight of palmitic acid (C16:0) and less than 2% by weight of lauric acid (C12:0); said percentages of acids referring to acids bound as acyl groups in glycerides in the fat and being based on the total weight of C8 to C24 fatty acids; and from 5% to 35% by weight of the combined amounts of StStSt and AStSt triglycerides, based on total triglycerides present in the composition, wherein St is stearic acid and A is arachidic acid; b) pasteurizing and homogenizing the mixture obtained in step a); c) stabilizing the pasteurized and homogenized mixture obtained in step b), preferably for at least 6 hours at from 3° C. to 7° C.; and d) aerating the stabilized mixture obtained in step c).

Preferably, the aerated fat emulsion produced in the method of the invention is an aerated fat emulsion according to the invention.

In a preferred embodiment, a method of making an aerated fat emulsion comprising the step of: a) providing a mixture comprising from 35% to 65% by weight of water; from 5% to 25% by weight of sugar; and from 20% to 55% by weight of a fat composition, wherein the fat composition comprises: from 90% to 99% by weight of a lauric fat comprising from 43% to 55% lauric acid (C12:0); said percentages of acids referring to acids bound as acyl groups in glycerides in the fat and being based on the total weight of C8 to C24 fatty acids; and from 1% to 10% by weight of an interesterified fat comprising from 40% to 65% by weight of total stearic acid (C18:0) and arachidic acid (C20:0); from 1% to 8% by weight of palmitic acid (C16:0) and from 0.1% to 1.0% by weight of lauric acid (C12:0); and from 9% to 26% by weight of the combined amounts of StStSt and AStSt triglycerides and a weight ratio of StOSt:StOO from 0.5 to 2.3, based on total triglycerides present in the composition, wherein St is stearic acid, A is arachidic acid and O is oleic acid; and from 48.0 to 67.5 solid fat content at 10° C.; and from 20.0 to 65.0 solid fat content at 25° C.; and from 20.0 to 55.0 solid fat content at 30° C.; and from 15.0 to 50.0 solid fat content at 35° C.; and from 10.0 to 40.0 solid fat content at 40° C.; measured on unstabilized fat according to ISO 8292-1; b) pasteurizing and homogenizing the mixture obtained in step a); c) stabilizing the pasteurized and homogenized mixture obtained in step b) for from 6 to 12 hours at from 3° C. to 7° C.; and d) aerating the stabilized mixture obtained in step c).

In step c) of the method according to the invention, the homogenizing is preferably performed in one single stage. The pressure during the homogenizing is preferably at least 100 bar, more preferably from 30 bar to 100 bar and even more preferably from 50 bar to 80 bar.

In step d) of the method according to the invention, the aerating is preferably performed for at least 1 minute, more preferably from 3 minutes to 7 minutes. Suitable apparatus for aerating, such as a mixer, is well known.

The invention also relates to the use of an aerated fat emulsion according to the invention in a confectionery product, or a bakery product.

The invention also relates to a confectionery product, or a bakery product comprising an aerated fat emulsion according to the invention.

The listing or discussion of an apparently prior-published document in this specification should not necessarily be taken as an acknowledgement that the document is part of the state of the art or is common general knowledge.

Preferences and options for a given aspect, embodiment, feature or parameter of the invention should, unless the context indicates otherwise, be regarded as having been disclosed in combination with any and all preferences and options for all other aspects, embodiments, features and parameters of the invention.

The following non-limiting examples illustrate the invention and do not limit its scope in any way. In the examples and throughout this specification, all percentages, parts and ratios are by weight unless indicated otherwise.

### EXAMPLES

### Example 1

Sal butter is chemically interesterified by using sodium methoxide as catalyst. After chemical interesterification, the interesterified sal is physically refined.

Shea butter is fractionated by using solvent to produce shea stearin. Shea stearin is then chemically interesterified by using sodium methoxide as catalyst. After chemical interesterification, the interesterified shea stearin is physically refined.

The analytical results of interesterified sal butter, interesterified shea stearin, sal butter and shea stearin are shown in Table 1.

TABLE 1
Fat composition of interesterified sal butter, interesterified
shea stearin, sal butter and shea stearin

| | Interesterified | Sal | Interesterified | Shea |
|---|---|---|---|---|
| | sal butter | butter | shea stearin | stearin |
| IV FAME | 40.5 | 38.8 | 32.5 | 32.3 |
| SAFA | 55.9 | 57.2 | 65.1 | 65.5 |
| MUFA | 41.2 | 40.7 | 32.0 | 31.6 |
| PUFA | 2.8 | 2.0 | 2.9 | 2.9 |
| TRANS | 0.5 | 0.5 | 0.1 | 0.1 |
| C12:0 | 0.3 | 0.0 | 0.2 | 0.1 |
| C14:0 | 0.2 | 0.0 | 0.1 | 0.1 |
| C16:0 | 6.9 | 5.8 | 3.4 | 4.0 |
| C18:0 | 41.1 | 43.4 | 59.3 | 59.3 |
| C18:1 | 40.9 | 40.4 | 31.9 | 31.5 |
| C18:2 | 2.3 | 1.6 | 2.8 | 2.9 |
| C18:3 | 0.4 | 0.3 | 0.1 | 0.1 |
| C20:0 | 6.5 | 7.0 | 1.7 | 1.7 |
| C20:1 | 0.3 | 0.3 | 0.1 | 0.0 |
| C20:2 | 0.1 | 0.1 | 0.0 | 0.0 |
| C22:0 | 0.5 | 0.5 | 0.2 | 0.1 |
| C24:0 | 0.2 | 0.2 | 0.1 | 0.1 |
| C18:0 + C20:0 | 47.6 | 50.4 | 61 | 61 |
| CN46 | 0.3 | 0.1 | 0.1 | 0.1 |
| CN48 | 1.1 | 0.2 | 0.8 | 0.4 |
| CN50 | 3.0 | 1.6 | 0.7 | 1.7 |
| CN52 | 15.6 | 15.2 | 10.2 | 8.9 |
| CN54 | 65.3 | 66.0 | 83.9 | 84.3 |
| CN56 | 14.8 | 16.7 | 4.4 | 4.5 |
| PPP | 0.6 | 0.0 | 0.2 | 0.0 |
| MOP | 0.5 | 0.0 | 0.3 | 0.0 |
| MLP | 0.3 | 0.0 | 0.1 | 0.0 |
| PPSt | 0.7 | 0.6 | 0.4 | 0.1 |
| POP | 1.5 | 1.0 | 0.0 | 1.3 |
| PLP | 0.4 | 0.1 | 0.0 | 0.3 |
| PStSt | 4.0 | 0.4 | 4.3 | 0.4 |
| POSt | 7.0 | 12.1 | 3.9 | 6.6 |
| POO | 4.4 | 3.3 | 1.2 | 0.6 |
| PLSt | 0.3 | 0.4 | 0.3 | 0.5 |
| PLO | 0.6 | 0.2 | 0.2 | 0.2 |
| PLL | 0.2 | 0.1 | 0.0 | 0.0 |
| StStSt | 9.3 | 0.6 | 21.8 | 2.1 |
| StOSt | 26.5 | 47.5 | 36.9 | 73.7 |
| StOO | 21.8 | 16.4 | 18.1 | 3.6 |
| StLSt | 0.8 | 0.9 | 2.1 | 5.4 |
| OOO | 7.1 | 2.7 | 3.0 | 0.4 |
| StLO | 1.4 | 0.7 | 2.7 | 0.4 |
| OLO | 0.9 | 0.3 | 0.6 | 0.1 |
| StLL | 0.0 | 0.1 | 0.0 | 0.0 |
| AStSt | 3.0 | 0.0 | 1.4 | 0.1 |
| AOSt | 5.7 | 9.1 | 1.5 | 3.3 |
| AOO | 2.9 | 2.6 | 0.4 | 0.2 |
| ALSt | 0.1 | 0.3 | 0.0 | 0.2 |
| StStSt + AStSt | 12.3 | 0.6 | 23.8 | 2.2 |
| StOSt/StOO | 1.2 | 2.9 | 2.0 | 20.5 |
| N5 | 56.8 | 71.1 | 71.0 | 89.7 |
| N10 | 51.0 | 68.6 | 67.0 | 90.9 |
| N15 | 42.5 | 59.6 | 61.4 | 88.0 |
| N20 | 37.9 | 41.0 | 61.6 | 80.6 |
| N25 | 30.0 | 6.1 | 61.2 | 73.4 |
| N30 | 28.2 | 1.6 | 53.2 | 60.0 |
| N35 | 21.4 | 0.5 | 40.7 | 6.1 |
| N40 | 16.1 | 0.0 | 33.7 | 2.6 |

In the above table:
Cx:y refers to a fatty acid having x carbon atoms and y double bonds; levels determined by GC-FAME (ISO 12966-2 and ISO 12966-4)
SAFA refers to saturated fatty acids;
MUFA refers to mono-unsaturated fatty acids;
PUFA refers to poly-unsaturated fatty acids;
IV FAME refers to calculated iodine value according to AOCS Cd 1c-85;
TRANS refers to trans fatty acids: unsaturated fatty acids having a double bond in a trans arrangement;
CNxx refers to a triglyceride having xx carbon atoms (excluding the carbon atoms from the glycerol, as is standard practice); levels determined by GC with pretreatment to remove the diglycerides eventually (AOCS Ce 5-86);
O, P, St, L and A refer to oleic, palmitic, stearic, linoleic and arachidic acids, respectively;
Triglyceride compositions: POSt, and other triglycerides were determined by GC (ISO 23275), wherein each GC peak includes triglycerides having the same fatty acids in different positions e.g., POSt is in the same signal peak as PStO and StPO; and
Nx refers to solid fat content determined by NMR on unstabilized fat measured at x° C. according to ISO 8292-1.

### Example 2

The whipped cream is produced following the recipe as shown in Table 2.

TABLE 2
Ingredient list of whipped cream

| Ingredients | Weight percentage % |
|---|---|
| Vegetable Fat | 34.0 |
| Sherex (E472b and E471) | 1.0 |
| Water | 48.0 |
| Lactose | 2.7 |
| Sugar | 12.0 |
| Sodium Caseinate | 1.0 |
| Sorbitol | 1.0 |
| Creamwhip414 (ME, CMC, Carr, Guar) | 0.3 |

Creamwhip414 is a blend of stabilizers, being microcrystalline cellulose E460(i), Cellulose gum E466, Carrageenan E407 and Guar E412. This is used to improve the stabilization of the whipped cream, to avoid draining from the foam and hence enhance the storage stability.

The whipped cream is made according to the following steps. The fat is completely melted and the emulsifier is added in the fat to form the fat phase. The other powdered ingredients are dissolved into lukewarm water. This water phase is heated to above 60° C. The fat phase is added into the water phase, pasteurized and homogenized (single stage homogenization at 70 bar). The cream is stabilized during one night for at least 8 hours at 5° C. The cream is whipped in the Hobart and the overrun and texture are measured.

The overrun is calculated as follows: (density in g/ml of unwhipped cream/density in g/ml of whipped cream)*100%.

The texture is measured by use of the Brookfield TexturePro CT 3-4500, Probe TAS, flat probe 38 mm with speed 0.5 mm/s and 5 mm depth. The value (g) is a measure for the force necessary to attain a given deformation.

### Example 3

Two fat compositions Fat A and Fat B are produced by blending coconut oil and interesterified sal butter. Fat A consists of 98% by weight coconut oil and 2% by weight interesterified sal butter. Fat B consists of 96% by weight coconut oil and 4% by weight interesterified sal butter. Additionally, fully hydrogenated palm kernel oil is used as a reference fat (Reference Fat C). 100% coconut oil is also used as a reference fat (Reference Fat D). Further, a comparative fat composition is made by 70% by weight coconut oil and 30% by weight interesterified sal butter (Comparative Fat E).

The analytical results of coconut oil and fully hydrogenated palm kernel are shown in Table 3.

TABLE 3
Fat composition of coconut oil and
fully hydrogenated palm kernel oil

| | | Fully |
|---|---|---|
| | Coconut | hydrogenated |
| | oil | palm kernel oil |
| TRANS | 0 | 0 |
| C8:0 | 6.0 | 3.2 |
| C10:0 | 5.3 | 3.3 |
| C12:0 | 46.5 | 48.2 |
| C14:0 | 19.5 | 16.3 |
| C16:0 | 10.4 | 8.5 |
| C18:0 | 3.1 | 20.1 |
| C18:1 | 7.3 | 0 |
| C18:2 | 1.8 | 0 |
| C18:3 | 0 | 0 |
| C20:0 | 0.1 | 0.2 |
| CN28 | 0.6 | 0.1 |
| CN30 | 2.7 | 1.0 |
| CN32 | 11.5 | 5.3 |
| CN34 | 15.9 | 8.2 |
| CN36 | 18.8 | 20.9 |
| CN38 | 17.2 | 16.5 |
| CN40 | 11.3 | 10.1 |
| CN42 | 8.2 | 9.4 |
| CN44 | 4.8 | 6.8 |
| CN46 | 2.7 | 5.6 |
| CN48 | 2.4 | 6.3 |
| CN50 | 1.9 | 3.2 |
| CN52 | 1.3 | 3.0 |
| CN54 | 0.8 | 2.9 |
| CN56 | 0 | 0.1 |

Fat A, Fat B, Reference Fat C, Reference Fat D and Comparative Fat E are used to produce whipped cream according to Example 2. The whipping time is 5 minutes. The results of overrun and texture are shown in Table 4.

TABLE 4
Analysis of overrun and texture of whipped creams by using Fat A,
Fat B, Reference Fat C, Reference Fat D and Comparative Fat E

| Vegetable fat | Overrun % | Texture |
|---|---|---|
| Fat A | 222 | 271 |
| Fat B | 207 | 404 |
| Reference Fat C | 272 | 100 |
| Reference Fat D | 185 | 200 |
| Comparative Fat E | 259 | 57 |

The results show that the whipped creams made by using Fat A and Fat B not only have the higher overrun thus better air incorporation compared to Reference Fat D but also have better texture properties compared to Reference Fat C and Comparative Fat E. It is considered that the texture is not acceptable when the texture value is lower than 150.

Rosettes are also made with the whipped cream. The piping of the whipped cream is evaluated and the shape of rosette is visually evaluated. The results are shown in Table 5.

TABLE 5
Rosette evaluation of whipped creams by using Fat A, Fat
B, Reference Fat C, Reference Fat D and Comparative Fat E

| | Piping during | |
|---|---|---|
| | the production | Shape of |
| Vegetable fat | of the rosettes | the rosettes |
| Fat A | Convenient | Firm |
| Fat B | Pressured | Stiff |
| Reference Fat C | Runny (too liquid) | Weak |
| Reference Fat D | Convenient | Weak |
| Comparative Fat E | Fast (too liquid) | Weak |

The results show that the process to produce rosettes by whipped creams using Fat A and Fat B is particularly convenient and desirable. Also, the rosettes produced by whipped creams using Fat A and Fat B have a firm and stiff texture which is particularly desired.

### Example 4

A fat composition Fat F is produced by blending coconut oil and interesterified sal butter. Fat F consists of 94% by weight coconut oil and 6% by weight interesterified sal butter. A comparative fat composition is made by blending 94% by weight coconut oil and 6% by weight sal butter (Comparative Fat G).

Fat F and Comparative Fat G are used to produce whipped cream according to Example 2. The whipping time is 5 minutes. The results of overrun and texture are shown in Table 6.

TABLE 6
Analysis of overrun and texture of whipped
creams by using Fat F and Comparative Fat G

| Vegetable fat | Overrun % | Texture |
|---|---|---|
| Fat F | 226 | 378 |
| Comparative Fat G | 212 | 344 |

The results show that the whipped cream made by using Fat F has a higher overrun and thus better air incorporation compared to Comparative Fat G.

### Example 5

A fat composition Fat H is produced by blending coconut oil and interesterified shea stearin. Fat H consists of 96% by weight coconut oil and 4% by weight interesterified shea stearin. A comparative fat composition is made by 96% by weight coconut oil and 4% by weight shea stearin (Comparative Fat I).

Fat H and Comparative Fat I are used to produce whipped cream according to Example 2. The whipping time is 5 minutes. The results of overrun and texture are shown in Table 7.

TABLE 7
Analysis of overrun and texture of whipped
creams by using Fat H and Comparative Fat I

| Vegetable fat | Overrun % | Texture |
|---|---|---|
| Fat H | 292 | 184 |
| Comparative Fat I | 213 | 335 |

The results show that the whipped cream made by using Fat H has a higher overrun and thus better air incorporation compared to Comparative Fat I.

1. An aerated fat emulsion comprising:
from 10% to 90% by weight of water; and
from 10% to 90% by weight of a fat composition, wherein the fat composition comprises:
from 75% to 99% by weight of a lauric fat comprising from 35% to 65% by weight of lauric acid (C12:Q), said percentage referring to lauric acid bound as acyl groups in glycerides in the fat and being based on the total weight of C8 to C24 fatty acids; and
from 1% to 25% by weight of an interesterified fat comprising from 30% to 70% by weight of total stearic acid (C18:0) and arachidic acid (C20:0); from 1% to 10% by weight of palmitic acid (C16:0) and less than 2% by weight of lauric acid (C12:0); said percentages of acids referring to acids bound as acyl groups in glycerides in the fat and being based on the total weight of C8 to C24 fatty acids; and from 5% to 35% by weight of the combined amounts of StStSt and AStSt triglycerides based on total triglycerides present in the composition, wherein St is stearic acid and A is arachidic acid.

2. The aerated fat emulsion according to claim 1, having an overrun from 100% to 400%.

3. The aerated fat emulsion according to claim 1, comprising:
from 20% to 80% by weight of water; and from 10% to 70% by weight of the fat composition.

4. The aerated fat emulsion according to any of claim 1, wherein the fat composition comprises from 80% to 99% by weight of the lauric fat.

5. The aerated fat emulsion according to claim 1, wherein the lauric fat of the fat composition comprises from 40% to 60% by weight of lauric acid (C12:0).

6. The aerated fat emulsion according to claim 1, wherein the lauric fat of the fat composition is selected from coconut oil, palm kernel oil, fully hydrogenated coconut oil, fully hydrogenated palm kernel oil, fractions thereof and mixtures thereof.

7. The aerated fat emulsion according to claim 1, wherein the fat composition comprises from 1% to 20% by weight of the interesterified fat.

8. The aerated fat emulsion according to claim 1, wherein the interesterified fat of the fat composition comprises from 35% to 68% by weight of total stearic acid (C18:0) and arachidic acid (C20:0); from 1% to 9% by weight of palmitic acid (C16:0); and from 0.0% to 1.5% by weight of lauric acid (C12:0).

9. The aerated fat emulsion according to claim 1, wherein the interesterified fat of the fat composition comprises from 7% to 30% by weight of the combined amounts of StStSt and AStSt triglycerides based on total triglycerides present in the composition, wherein St is stearic acid and A is arachidic acid.

10. The aerated fat emulsion according to claim 1, wherein the interesterified fat of the fat composition has a weight ratio of StOStStOO less than 2.5, wherein St is stearic acid and O is oleic acid.

11. The aerated fat emulsion according to claim 1, wherein the interesterified fat of the fat composition has:
from 45.0 to 68.0 solid fat content at 10° C.; and/or from 15.0 to 70.0 solid fat content at 25° C.; and/or from 15.0 to 59.0 solid fat content at 30° C.; and/or from 10.0 to 55.0 solid fat content at 35° C; and/or from 5.0 to 45.0 solid fat content at 40° C.;
measured on unstabilized fat according to ISO 8292-1.

12. The aerated fat emulsion according to claim 1, wherein the interesterified fat of the fat composition is selected from interesterified shea butter, interesterified shea stearin, interesterified sal butter, interesterified sal stearin, interesterified kokum butter, interesterified kokum butter stearin, interesterified cocoa butter, interesterified cocoa butter stearin and mixtures thereof.

13. The aerated fat emulsion according to claim 1, comprising:
from 35% to 65% by weight of water;
from 20% to 55% by weight of the fat composition; and
from 5% to 25% by weight of sugar.

14. The aerated fat emulsion according to claim 1, which is whipped cream.

15. A method of making an aerated fat emulsion comprising the steps of:
a) providing a mixture comprising from 10% to 90% by weight of water and from 10% to 90% by weight of a fat composition, wherein the fat composition comprises: from 75% to 99% by weight of a lauric fat comprising from 35% to 65% lauric acid (C12:0); and from 1% to 25% by weight of an interesterified fat comprising from 30% to 70% by weight of total stearic acid (C18:0) and arachidic acid (C20:0); from 1% to 10% by weight of palmitic acid (C16:0) and less than 2% by weight of lauric acid (C12:0); said percentages of acids referring to acids bound as acyl groups in glycerides in the fat and being based on the total weight of C8 to C24 fatty acids; and from 5% to 35% by weight of the combined amounts of StStSt and AStSt triglycerides, based on total triglycerides present in the composition, wherein St is stearic acid and A is arachidic acid;
b) pasteurizing and homogenizing the mixture obtained in step a);
c) stabilizing the pasteurized and homogenized mixture obtained in step b); and d) aerating the stabilized mixture obtained in step c).

16. (canceled)

17. A confectionery product or bakery product comprising an aerated fat emulsion of claim 1.
